(19) United States
(12) Patent Application Publication
(10) Pub. No.: US 2022/0152438 A1
(43) Pub. Date: May 19, 2022

(54) FIRE EXTINGUISHING SYSTEM AND METHOD FOR ELECTRONIC COMPONENTS

(71) Applicants: Jih-Hsing LEE, Taoyuan City (TW); Yu-Kuang WANG, Taoyuan City (TW); Chuan-Tse LIN, Taoyuan City (TW); Chen-Chou WEN, Taoyuan City (TW); Ming-Ju CHUANG, Taoyuan City (TW); Tzu-Hung CHEN, Taoyuan City (TW)

(72) Inventors: Jih-Hsing LEE, Taoyuan City (TW); Yu-Kuang WANG, Taoyuan City (TW); Chuan-Tse LIN, Taoyuan City (TW); Chen-Chou WEN, Taoyuan City (TW); Ming-Ju CHUANG, Taoyuan City (TW); Tzu-Hung CHEN, Taoyuan City (TW)

(21) Appl. No.: 17/520,630

(22) Filed: Nov. 6, 2021

(30) Foreign Application Priority Data
Nov. 18, 2020 (TW) 109140285

(51) Int. Cl. A62C 3/16; A62C 2/24; A62C 37/14

(52) U.S. Cl. CPC A62C 3/16; B66C 13/18; A62C 37/14; A62C 2/247

(57) ABSTRACT

Herein disclosed is a fire extinguishing system and a fire extinguishing method for electronic components. The fire extinguishing system comprises a fire extinguishing device, a control device, and a crane device. The fire extinguishing device comprises a camera module and a frame. The camera module captures a scene image related to a storage location in a machine. The frame has a fire tank for receiving an electronic component in the storage location. The control device receives the scene image and selectively sends a fetch instruction according to a status of the storage location. The crane device fetches the electronic component from the storage location to the fire tank according to the fetch instruction. Wherein the frame is fireproof.

### CROSS REFERENCE TO RELATED APPLICATION

The present application claims priority to Taiwan patent application Serial No. 109140285 filed on Nov. 18, 2020, the entire content of which is incorporated by reference to this application.

### 1. Field of the Invention

The present invention pertains to a fire extinguishing system and method, more specifically to a fire extinguishing system and method for electronic components.

### 2. Description of the Prior Art

To ensure that batteries can work normally, each of the batteries needs to be placed in a battery formation equipment while manufacturing, and the battery formation equipment can perform a series of battery formation procedures to the batteries. Generally speaking, there can be multiple storage locations in the battery formation equipment, each storage location can accommodate at least one tray, and at least one battery can be accommodated in the tray. Since the battery may have various defects, such as an internal short circuit of a battery cell or other problems that can cause abnormal charging and discharging, some of the batteries may be swollen, overheated, smoking or catching fire when the battery formation equipment is processing the battery formation procedures.

Traditionally, in order to deal with the abnormal batteries in the battery formation procedures, once the battery in the storage location causes an abnormal warning, it is often necessary for on-site personnel to check and eliminate various accidents. However, if the accident is not eliminated in time, it will not only expose the on-site personnel to potential dangers, but also may expand the damage to the battery formation equipment or the batteries in other locations, and even cause more serious occupational accidents. Therefore, the industry needs a new fire extinguishing system and method that can quickly isolate the electronic component having problems in the storage location and timely provide fire extinguishing means.

### SUMMARY OF THE INVENTION

The present invention provides a fire extinguishing system for electronic components, which can quickly fetch an electronic component in a storage location and put it into a fireproof fire tank by a crane device. Therefore, the fire extinguishing system can prevent abnormal electronic components from causing greater problems.

The present invention discloses a fire extinguishing system for electronic components comprising a fire extinguishing device, a control device, and a crane device. The fire extinguishing device comprises a camera module and a frame. The camera module captures a scene image related to a storage location in a machine. The frame has a fire tank for receiving an electronic component in the storage location. The control device receives the scene image and selectively sends a fetch instruction according to a status of the storage location. The crane device fetches the electronic component from the storage location to the fire tank according to the fetch instruction. Wherein the frame is fireproof.

In some embodiments, the fire extinguishing device may further comprise a roll-up door, disposed on the frame, for closing the fire tank selectively, and the roll-up door is fireproof. Besides, the fire extinguishing device may further comprise a fire extinguishing module, disposed on the frame, for releasing a fire extinguishing agent into the fire tank when a temperature of the fire tank reaches a threshold temperature. In addition, the fire extinguishing module may further comprise a fire detection tube, disposed in the fire tank, for storing the fire extinguishing agent, and the fire detection tube may break to release the extinguishing agent into the fire tank when the temperature of the fire tank reaches the threshold temperature. Moreover, the fire extinguishing module may further comprise a fire cylinder, connected to the fire detection tube, for filling the fire extinguishing agent into the fire detection tube.

The present invention provides a fire extinguishing method for electronic components, which can check a status of a storage location from an image, and move an electronic component in the storage location to a fire tank according to the status of the storage location. Therefore, the fire extinguishing method can prevent abnormal electronic components from causing greater problems.

The present invention discloses a fire extinguishing method for electronic components comprises the following steps: capturing a scene image related to a storage location in a machine, selectively sending a fetch instruction according to a status of the storage location, and providing a crane device for fetching the electronic component from the storage location to the fire tank according to the fetch instruction.

In some embodiments, in the step of selectively sending the fetch instruction may further comprise the following steps: determining whether the storage location is on fire or smoke, and sending the fetch instruction when there is no fire or smoke in the storage location. Besides, in the step of providing the crane device for fetching the electronic component from the storage location to the fire tank according to the fetch instruction may further comprise the following steps: providing a roll-up door made of fireproof materials, and closing the fire tank by the roll-up door when the electronic component is fetched from the storage location to the fire tank. In addition, the fire extinguishing method for electronic components may further comprise the step of releasing a fire extinguishing agent into the fire tank when a temperature of the fire tank reaches a threshold temperature.

Based on the above, the fire extinguishing system and method for the electronic components provided by the present invention can check the status of the storage location by the image, and use the crane device to quickly fetch the electronic component in the storage location according to the status of the storage location. The abnormal electronic component can be put into the fire tank to avoid greater problems.

### BRIEF DESCRIPTION OF THE APPENDED DRAWINGS

FIG. 1 is a schematic diagram of the fire extinguishing system for electronic components in accordance with an embodiment of the present invention.

FIG. 2 is a perspective view of the fire extinguishing device in accordance with an embodiment of the present invention.

FIG. 3 is a cross-section view of the fire extinguishing device along AA line in FIG. 2.

FIG. 4 is a cross-section view of the fire extinguishing device along BB line in FIG. 2.

FIG. 5 is a perspective view of a part of the fire extinguishing device in accordance with an embodiment of the present invention.

FIG. 6 is a flowchart of the fire extinguishing method for electronic components in accordance with an embodiment of the present invention.

### DETAILED DESCRIPTION OF THE INVENTION

The features, objections, and functions of the present invention are further disclosed below. However, it is only a few of the possible embodiments of the present invention, and the scope of the present invention is not limited thereto; that is, the equivalent changes and modifications done in accordance with the claims of the present invention will remain the subject of the present invention. Without departing from the spirit and scope of the invention, it should be considered as further enablement of the invention.

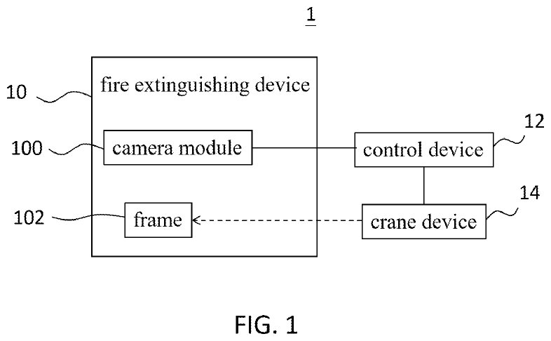

Please refer to FIG. 1, FIG. 1 is a schematic diagram of the fire extinguishing system for electronic components in accordance with an embodiment of the present invention. As shown in FIG. 1, the fire extinguishing system 1 of this embodiment can be used to determine whether a machine (not shown in the figure) has a fire risk, and provides a corresponding fire extinguishing mechanism. In one example, the machine described in this embodiment may have multiple storage locations (not shown), each storage location may correspond to at least one electronic component (not shown), and the electronic component can be fetched out of the storage location. In practice, a plurality of electronic components can be placed on a tray, and the tray is detachably accommodated in the storage location. This embodiment does not limit the functions of the machine and the types of electronic components. For the convenience of description, the machine mentioned in this embodiment may be a battery formation equipment, and the electronic components mentioned in this embodiment may be a battery which requires a battery formation procedure. It can be seen from FIG. 1 that the fire extinguishing system 1 for electronic components of this embodiment comprises a fire extinguishing device 10, a control device 12, and a crane device 14. The control device 12 can be physically or wirelessly connected to the fire extinguishing device 10 and the crane devices 14, respectively. The components of the fire extinguishing system 1 will be described below.

The fire extinguishing device 10 comprises a camera module 100 and a frame 102. The camera module 100 is used to capture images in front of, behind, or around the fire extinguishing device 10 (i.e. live images), and the frame 102 can be regarded as the structure of the fire extinguishing device 10. In detail, the camera module 100 may include one or more cameras, and this embodiment does not limit the types of cameras, for example, it may be a simple lens, a fisheye camera or a PTZ (pan-tilt-zoom) camera. In addition, the live images captured by the camera module 100 may include images of one or more storage locations in the machine. Of course, if the performance of the camera module 100 is good, it is possible, but not limited, to see the electronic component in the storage location from the live images. In one example, the camera module 100 can be fixed on the frame 102 and can move synchronously with the frame 102. This embodiment does not limit the installation position of the camera module 100, the camera module 100 may not be installed on the frame 102, but may be installed in front of the machine to be photographed, so that the live images may show several storage locations within a range.

In addition, the frame 102 may have a fire tank (not shown in FIG. 1) for receiving the electronic component from the storage location. In practice, the frame 102 can be a hollow structure, and the internal space of the frame 102 can be defined as the fire tank. This embodiment does not limit whether the fire tank is a closed space. For example, the fire tank may not be an air-tight structure, but the frame 102 itself should be made of fire-resistant materials. Person having ordinary skill in the art should understand that since the electronic component received by the fire tank has the risk of catching fire, there should be no combustible structures around the fire tank, and the fire tank should be able to withstand relatively high temperatures. Therefore, the fire tank can reduce the safety problems when the electronic component does catch fire accidentally.

The control device 12 can receive at least one image from the camera module 100, and can send a fetch instruction to the crane device 14. The crane device 14 can fetch the electronic component in the storage location accordingly. In practice, the control device 12 can also be electrically connected to the machine to receive an internal detection signal of the machine, such as a temperature signal for each storage location. If the temperature of a certain storage location is too high, the control device 12 will receive an overheating warning from the machine. At this time, the control device 12 or the machine can stop the operations of all storage locations and start monitoring the correspond image or live image. In one example, the control device 12 can use the image analysis technology or the artificial intelligence technology to automatically determine the status of the storage location in time and take corresponding means. For example, the control device 12 can analyze whether the storage location has obviously caught fire or smoke from the image. When the storage location has obviously caught fire or smoke, it should be in the status of “not fetchable” or not suitable for fetching the electronic component. If the crane device 14 forcibly fetch the electronic component in the storage location which is on fire, it may cause unpredictable accidents, such as accelerating the spread of the fire or generating a large amount of dense smoke. Therefore, if the image shows that the status of the storage location is not suitable for fetching the electronic component in the storage location, the control device 12 will not send the fetch instruction to the crane device 14. At this time, the control device 12 can send a warning signal to the fire crew in the building. For example, the warning signal can not only notify attendance, but also roughly describe what happened on the spot, so that the fire crew can be prepared in advance.

On the other hand, if the control device 12 determines that the storage location has not obviously caught fire or smoke from the image, the control device 12 can infer the status of the storage location is fetchable, which means that the electronic component in the storage location is still able to be fetched properly. At this time, the control device 12 can send the fetch instruction to the crane device 14 to allow the crane device 14 to fetch the electronic component in the storage location and put it into a fireproof fire tank, the fire tank can prevent the electronic component from burning in the storage location and cause more serious problem and damage. Similarly, the control device 12 can also choose to send a warning signal to the fire crew in the building at the same time. The warning signal can inform the fire crew, and let the fire crew deal with the electronic component in the fire tank.

It is worth mentioning that after the control device 12 of this embodiment obtains the image of the camera module 100, the control device 12 can also play the image, especially the real-time image, on a remote screen, and then the on-site personnel can also check the current status of the storage location by themselves. In other words, the on-site personnel do not need to be in front of the location, and can check whether the location is on fire or smoke through the screen. Similarly, if there is no obvious fire or smoke in the storage location, the on-site personnel can operate the control device 12 to send the fetch instruction to the crane device 14 so that the crane device 14 can take out the electronic component in the storage location and put it into the fire tank. If the status of the storage location indicates having fire or smoke, the control device 12 can directly notify the fire crew to deal with it.

In addition, the crane device 14 may be arranged around the machine, and may have a robotic arm to fetch one electronic component in the storage location, or fetch a tray accommodating multiple electronic components placed in the storage location. In one example, when the machine operates normally, both the control device 12 and the crane device 14 have their routine operations. For example, the control device 12 can control the machine to work, and the crane device 14 can be used to automatically transport one or more electronic components in the storage location to the transportation belt or other test stations, or transport the electronic components in the transportation belt or other test stations to the storage location. Only when the temperature of a specific storage location in the machine is too high, the control device 12 will send a fetch instruction to the crane device 14 to make crane device 14 will move the electronic component from the storage location to the fire tank. In other words, the control device 12 and the crane devices 14 may not be dedicated to the fire extinguishing system 1.

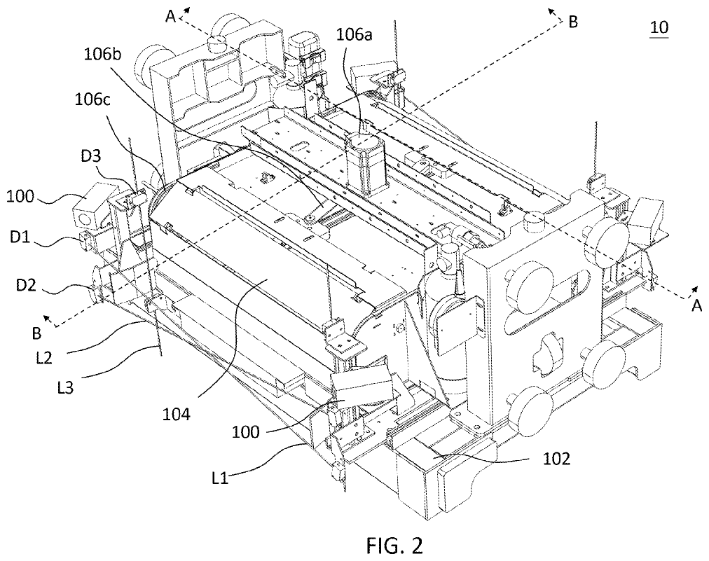

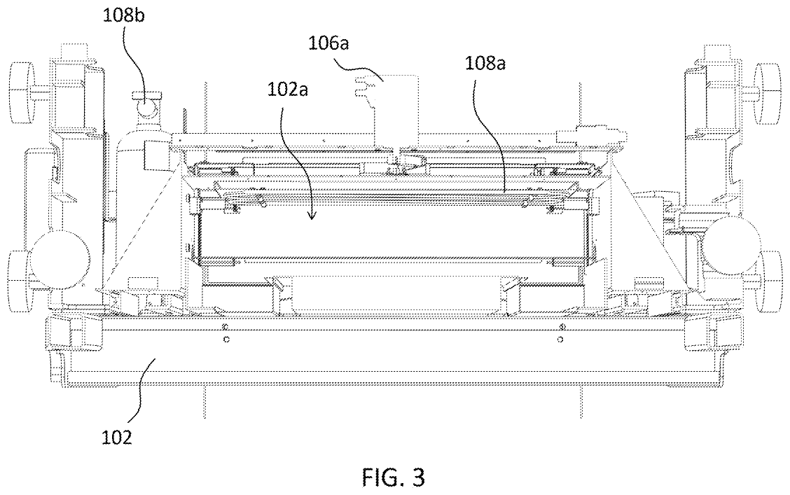

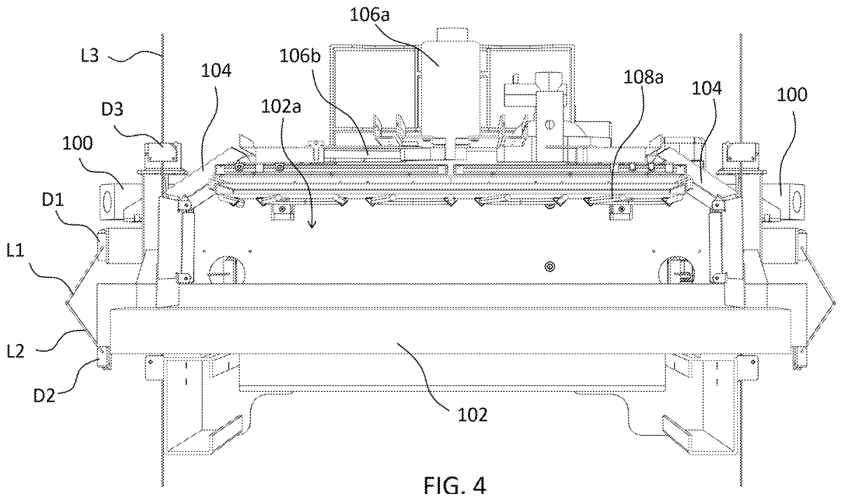

In order to describe the fire extinguishing device 10 more clearly, please refer to FIGS. 1, 2, 3 and 4 together. FIG. 2 is a perspective view of the fire extinguishing device in accordance with an embodiment of the present invention. FIG. 3 is a cross-section view of the fire extinguishing device along AA line in FIG. 2. FIG. 4 is a cross-section view of the fire extinguishing device along BB line in FIG. 2. As shown in the figures, the fire extinguishing device 10 has a camera module 100 and a frame 102, and the camera module 100 is installed on the frame 102. Taking the example of FIG. 2, there may be a hollow space inside the frame 102, and the hollow space may be defined as a fire tank 102a, and the fire tank 102a may have openings on both ends of the BB line. Assuming this embodiment defines the fire tank 102a at both ends of the BB line as the front and rear sides, FIG. 2 means that each side of the fire tank 102a has one opening that can be connected to the fire tank 102a. In one example, the fire tank 102a can have a symmetrical structure viewed from both sides of the AA line, and the crane device 14 can put the electronic component into the fire tank 102a from the opening on the front side or the rear side of the fire tank 102a.

In practice, in order to ensure that the crane device 14 can correctly place the electronic component into the fire tank 102a, the fire extinguishing device 10 may also include multiple photodetectors, such as the photodetectors D1, D2, and D3 shown in FIG. 2. Here, the photodetectors D1 can emit and receive the detection light L1. The photodetectors D1 can be arranged in pairs, for example, the photodetector D1 on one side is used to emit the detection light L1, and the photodetector D1 on the other side is used to receive the detection light L1. When the detection light L1 is blocked, it can be inferred that one or more electronic components pass through the path between the photodetectors D1. Similarly, the photodetectors D2 can emit and receive the detection light L2, and the photodetectors D3 can emit and receive the detection light L3, the function of the photodetector D2 and the photodetector D3 are the same as the photodetectors D1 and will not be repeated in this embodiment. In addition, it can be seen from FIG. 2 that the photodetectors D1, the photodetectors D2, and the photodetectors D3 are arranged at the opening on the same side of the fire tank 102a, and the opening on the other side of the fire tank 102a may also have other photodetectors arranged symmetrically. It is worth mentioning that if the photodetectors D1, the photodetectors D2, and the photodetectors D3 are not applied to the fire extinguishing device 10, it should not affect the overall function of the fire extinguishing device 10. That is, the photodetectors D1 and the photodetectors D2 and the photodetectors D3 may be unnecessary components.

The fire extinguishing device 10 may have more than one camera module 100. In the example shown in FIG. 2, four camera modules 100 are used to capture live images, each of the front and rear sides of the fire tank 102a can be arranged with two camera modules 100. One reason for the fire extinguishing device 10 is provided with multiple camera modules 100 is to avoid blind spots in single image, since the images of the opening can be captured by the multiple camera modules 100 from several angles. In addition, the control device 12 may combine the images captured by the four camera modules 100, for example, by using the image stitching technology to generate a wider or perspective image. Although FIG. 2 shows that four camera modules 100 are respectively disposed at the four corners of the frame 102, this embodiment is not limited to this arrangement. For example, if the camera module 100 has a wide-angle lens or a fish-eye lens, the fire extinguishing device 10 may apply only one or fewer camera modules 100 to get the achieve the wider or perspective image.

In one example, the crane device 14 may use a robotic arm (not shown) to clamp the frame 102 of the fire extinguishing device 10, so that the fire extinguishing device 10 can move with the robotic arm of the crane device 14. For example, suppose that the control device 12 will receive an overheating warning from a storage location of the machine. At this time, the control device 12 can control the crane device 14 to move the robotic arm to the front of the storage location for standby, and then the camera module 100 of the fire extinguishing device 10 observes the status of the storage location by capturing one or more images. If the electronic component in the storage location are able to be removed properly, the control device 12 can quickly allow the crane device 14 to remove the electronic component in the storage location by fetching it out, so as to save the moving time of the crane device 14. Of course, this embodiment does not limit the position of the frame 102 of the fire extinguishing device 10 held by the robotic arm, as long as the crane device 14 is able to move the fire extinguishing device 10.

On the other hand, this embodiment demonstrates that the fire extinguishing device 10 may have a roll-up door 104, and the roll-up door 104 may be made of a fireproof material. In an example, each of the openings on the front and rear sides of the fire tank 102a can be provided with one roll-up door 104. The two roll-up doors 104 can be used to close the openings of the fire tank 102a, so that the fire tank 102a can form a relatively closed space. This embodiment does not limit whether the fire tank 102a is airtight. Person having ordinary skill in the art should understand that as long as the fire tank 102a is fireproof and there are no combustibles around it, the fire should be controlled inside the fire tank 102a. In practice, one of the functions of the roll-up door 104 is to prevent the high-temperature flame from directly escaping, so as to prevent the fire from spreading out of the fire tank 102a. In other words, assuming that the space of the fire tank 102a is large enough, and the flame is relatively difficult to escape from the openings on the front and rear sides of the fire tank 102a, the roll-up door 104 may be an unnecessary element. It is worth mentioning that the function of the roll-up door 104 is to block open flames, although the roll-up door 10 is shown in the figures, it should not be limited to this type of door. For example, the openings on the front and rear sides of the fire tank 102a may also be covered by left-opening, right-opening, or side-opening doors.

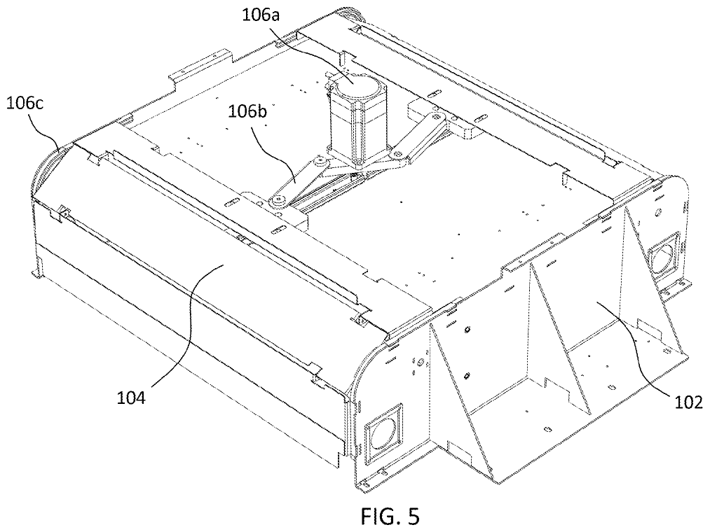

The fire extinguishing device 10 also has related structures that can drive the roll-up door 104, such as a motor 106a, connecting rods 106b, and a set of sliding rails 106c. In an example, each of the front and rear sides of the fire tank 102a can have the slide rails 106c, and the roll-up door 104 can be arranged in the slide rails 106c and move the track of the slide rails 106c to open or close the openings on the front and rear sides of the fire tank 102a. In addition, the motor 106a can be connected to the connecting rods 106b, and each connecting rod 106b can be connected to one of the roll-up doors 104 of the fire tank 102a. The motor 106a can be driven to pull or release the connecting rods 106b at the same time, and then the connecting rods 106b can drive the roll-up doors 104 at the front and rear sides of the fire tank 102a simultaneously. In order to show the structure of the roll-up door 104 and its surroundings, FIG. 5 is a perspective view of a part of the fire extinguishing device in accordance with an embodiment of the present invention. As shown in FIG. 5, the motor 106a, the connecting rods 106b, and the sliding rails 106c can be arranged at different positions on the frame 102. For example, the motor 106a and the connecting rod 106b can be arranged on the top of the frame 102, and the sliding rail 106c is arranged at the openings on the front and rear sides of the fire tank 102a.

In practice, if the roll-up door 104 is to be pulled up, the motor 106a can be rotated under the control of the control device 12, and while rotating, the connecting rods 106b are driven to be folded toward the center, and the roll-up door 104 can be pulled toward the top of the frame 102, thereby exposing the front and rear openings of the fire tank 102a. On the contrary, if the roll-up door 104 is to be lowered, the motor 106a can be controlled by the control device 12 to rotate in another direction, and while rotating, it drives the connecting rods 106b to extend outward, and push the roll-up door 104 away from the top of the frame 102, thereby closing the openings on the front and rear sides of the fire tank 102a. Of course, there are many ways to pull up or lower the roll-up door 104, the mechanism of this embodiment is only an example. Person having ordinary skill in the art may also use other structures to achieve similar functions.

The fire tank 102a is not only designed for isolating fire, but also the fire tank 102a may have a fire extinguishing mechanism in this embodiment. As shown in FIG. 3 and FIG. 4, a fire detection tube 108a may be provided in the fire tank 102a, and the fire detection tube 108a may be, for example, disposed on the top surface of the inner side of the fire tank 102a. And, the fire detection tube 108a may store a fire extinguishing agent. Here, the fire detection tube 108a may also be connected to a fire cylinder 108b. The fire cylinder 108b, arranged on the frame 102 and connected with the fire detection tube 108a, can fill the fire detection tube 108a with the fire extinguishing agent. In practice, the fire cylinder 108b can be a high-pressure fire cylinder containing a fire extinguishing agent, so that the inside of the fire detection tube 108a will bear a considerable pressure. Because the fire detection tube 108a has a tube wall that is not resistant to high temperatures, when the temperature in the fire tank 102a reaches the threshold temperature, the tube wall of the fire detection tube 108a will undergo a qualitative change, resulting in the tube wall being unable to withstand the pressure of the internal fire extinguishing agent. When the tube wall of the fire detection tube 108a breaks, thereby continuously releasing the fire extinguishing agent stored inside the fire detection tube 108a until the fire extinguishing agent inside the fire cylinder 108b is mostly consumed. In one example, the fire detection tube 108a is a curved pipe, and both ends of the fire detection tube 108a can be connected to the fire cylinder 108b to ensure that the amount of the fire extinguishing agent is sufficient to extinguish fire in the fire tank 102a.

The fire detection tube 108a and the fire cylinder 108b can be, but not limited to, defined together as a fire extinguishing module. For example, instead of applying the fire detection tube 108a, a temperature detector (not shown) may be used to replace the fire detection tube 108a. When the temperature detector detects that the temperature in the fire tank 102a reaches the threshold temperature, the temperature detector can give a control signal to make the fire cylinder 108b spray the stored fire extinguishing agent. In this example, the temperature detector and the fire cylinder 108b can be defined together as the fire extinguishing module. In addition, the fire extinguishing agent may contain various materials for extinguishing fire of the electronic component, for example, NOVEC 1230 or similar clean fire extinguishing agents can be used to reduce toxicity and reduce greenhouse gases for the better environmental protection.

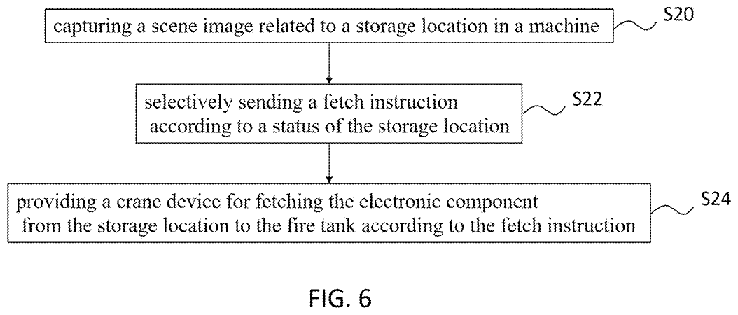

In order to explain the fire extinguishing method of the electronic component of the present invention, please refer to FIG. 1 to FIG. 6 together. FIG. 6 is a flowchart of the fire extinguishing method for electronic components in accordance with an embodiment of the present invention. As shown in the figures, in step S20, the camera module 100 can capture the image, and the image is associated with the storage location in the machine. In step S22, the control device 12 may selectively send a fetch instruction to the crane device 14 according to the status of the storage location in the image. In step S24, the crane device 14 can move the electronic component from the storage location to the fire tank 102a in the fire extinguishing device 10 according to the fetch instruction. Since the detailed steps of the fire extinguishing method of the electronic component of the present invention have been described in the foregoing embodiment, this embodiment will not be repeated here.

In summary, the fire extinguishing system and method provided by the present invention can not only use the camera module to quickly confirm the status of the storage location, but also control the crane device to fetch the electronic component in the storage location into the fireproof fire tank. If the electronic component in the fire tank is on fire, the fire extinguishing mechanism in the fire tank can also be activated to prevent the flame from spreading out the storage location to the machine or the surrounding environment.

What is claimed is:

1. A fire extinguishing system for electronic components, comprising:
a fire extinguishing device, comprising:
a camera module capturing a scene image related to a storage location in a machine; and
a frame having a fire tank for receiving an electronic component in the storage location;
a control device receiving the scene image and selectively sending a fetch instruction according to a status of the storage location; and
a crane device fetching the electronic component from the storage location to the fire tank according to the fetch instruction;
wherein the frame is fireproof.

2. The fire extinguishing system for electronic components according to claim 1, wherein the fire extinguishing device further comprises:
a roll-up door, disposed on the frame, for closing the fire tank selectively;
wherein the roll-up door is fireproof.

3. The fire extinguishing system for electronic components according to claim 1, wherein the fire extinguishing device further comprises:
a fire extinguishing module, disposed on the frame, for releasing a fire extinguishing agent into the fire tank when a temperature of the fire tank reaches a threshold temperature.

4. The fire extinguishing system for electronic components according to claim 3, wherein the fire extinguishing module further comprises:
a fire detection tube disposed in the fire tank;
wherein the fire extinguishing agent is stored inside the fire detection tube;
wherein the fire detection tube breaks to release the extinguishing agent into the fire tank when the temperature of the fire tank reaches the threshold temperature.

5. The fire extinguishing system for electronic components according to claim 4, wherein the fire extinguishing module further comprises a fire cylinder, connected to the fire detection tube, for filling the fire extinguishing agent into the fire detection tube.

6. A fire extinguishing method for electronic components, comprising:
capturing a scene image related to a storage location in a machine;
selectively sending a fetch instruction according to a status of the storage location; and
providing a crane device for fetching the electronic component from the storage location to the fire tank according to the fetch instruction.

7. The fire extinguishing method for electronic components according to claim 6, wherein in the step of selectively sending the fetch instruction further comprises the following steps:
determining whether the storage location is on fire or smoke; and
sending the fetch instruction when there is no fire or smoke in the storage location.

8. The fire extinguishing method for electronic components according to claim 6, wherein in the step of providing the crane device for fetching the electronic component from the storage location to the fire tank according to the fetch instruction further comprises the following steps:
providing a roll-up door made of fireproof materials; and
closing the fire tank by the roll-up door when the electronic component is fetched from the storage location to the fire tank.

9. The fire extinguishing method for electronic components according to claim 6, further comprising:
releasing a fire extinguishing agent into the fire tank when a temperature of the fire tank reaches a threshold temperature.
